(19) United States
(12) Patent Application Publication
(10) Pub. No.: US 2004/0221608 A1
(43) Pub. Date: Nov. 11, 2004

(54) Combined ice/beverage dispenser and icemaker with heated drip tray

(76) Inventor: Thaddeus M. Jablonski, Palatine, IL (US)

Correspondence Address: Robert A. Lloyd, Pyle & Piontek, Suite 850, 221 N. LaSalle Street, Chicago, IL, 60601, US

(21) Appl. No.: 10/839,069

(22) Filed: May 5, 2004

Related U.S. Application Data
(60) Provisional application No. 60/469,515, filed on May 9, 2003.

(51) Int. Cl. F25C 1/00; F25C 5/18; B67D 5/62

(52) U.S. Cl. 62/344; 62/390

(57) ABSTRACT

The present invention includes an ice and beverage dispenser having an icemaker associated therewith. The icemaker has a refrigeration system that includes a compressor, a condenser and an evaporator. A refrigerant line exiting the condenser is routed through a drip tray of the dispenser before returning to an expansion valve for release of refrigerant into the evaporator. The refrigerant exiting the condenser is at a temperature of from about 100° to 140° F. and provides sufficient heat energy, as it passes through the drip tray, to melt any ice in the drip tray. The additional cooling of the refrigerant as it melts the ice prior to expansion of the refrigerant into the evaporator improves the cooling performance and efficiency of the refrigeration system.

This application claims benefit of provisional application Serial No. 60/469,515, filed May 9, 2003.

### FIELD OF THE INVENTION

The present invention relates generally to ice and beverage dispensing equipment, and more specifically to such equipment having a capability to prevent ice buildup on and in a drip tray thereof.

### BACKGROUND OF THE INVENTION

Combination ice and beverage dispensing machines typically have several beverage dispensing valves and a single ice dispensing chute positioned on the dispenser above a drip tray. Such dispensers also include an ice retaining bin having an ice dispensing mechanism for delivering ice on demand to and through the ice dispense chute. The drip tray serves as a platform on which a receptacle, such as a cup, can be placed as it is being filled with beverage and ice. The drip tray support surface or cup rest usually comprises a wire grate with spacing between the wires to allow any spilled beverage to flow through the grate to a lower drain.

The accumulation of ice in the drip tray of an ice/beverage dispenser is an ever present problem in the beverage dispensing industry. Since a cup is often hand held during dispensing, and particularly when being filled with ice, it is not always necessary that the drip tray grate provide a cup rest in the area directly below the ice dispensing chute. Thus, the grate wire spacing below the ice chute can be increased or eliminated to permit any spilled ice particles to fall directly into the drip tray and not build up on the grate. The inherent volume of the drip tray below the cup rest grate can often accommodate enough ice during casual use of the dispenser that buildup of ice above the level of the grate is not a problem. However, during periods of high use sufficient ice can spill into the drip tray faster than the ice can melt, such that a significant volume of ice can accumulate in the tray and extend up above the cup rest surface of the grate. A buildup of ice in this manner can interfere with physical placement of a cup below the ice dispensing chute and will eventually lead to ice falling from the drip tray onto the floor area surrounding the dispenser. Thus, in addition to making use of the dispenser more difficult, drip tray ice buildup can result in the floor area around the dispenser becoming wet and having particles of ice thereon, which presents cleanliness and safety hazard problems.

Attempts have been made to prevent ice buildup on and in drip trays. Other than simply manually removing the ice, one approach has been to pour hot water into the drip tray to melt residual ice. However, this type of task is not something that is regularly scheduled and may not be timely performed. It also is possible that a buildup of ice can happen quickly enough that its presence may not be appreciated before a dangerous condition develops. Electrical resistive heating elements have been used to melt accumulated drip tray ice, but the cost of using such elements can be high if separate temperature sensing and control means are used to maintain and operate the heating elements within a predetermined temperature range, and where no controls are used in order to reduce initial costs, the heating element simply runs continuously, wasting power when heating is not required. Also, should such control mechanisms fail, the heating elements can possibly reach temperatures above what would be practical or safe for standard plastic drip trays.

Another approach to controlling an accumulation of drip tray ice is described in U.S. Pat. No. 6,107,607, issued Aug. 22, 2000 to Thaddeus M. Jablonski, the present inventor, assigned to the assignee of the present invention and the teachings of which are specifically incorporated herein by reference. According to said patent, the drip tray is rid of ice through an electrical heating element placed in the tray and having a positive temperature coefficient. In this manner, when ice is present in the tray the element is cooled, causing its electrical resistance to decrease and an increased current to flow through the element to heat the element and melt the ice. This approach works well, is less expensive to implement and generally uses less energy than conventional heating elements placed in drip trays, but it nevertheless requires the use of further energy.

Accordingly, it would be desirable to have a way of eliminating or minimizing drip tray ice buildup problems in a manner that does not require manual intervention or the use of additional energy and that is safe, reliable and of relatively low cost.

### OBJECTS OF THE INVENTION

An object of the present invention is to provide a safe and reliable system for preventing an accumulation of ice in a drip tray of an ice and beverage dispenser.

Another object is to provide such a system in which an accumulation of ice in the drip tray is prevented by melting any ice as may enter the drip tray.

A further object is to provide such a system in which heat absorbed by ice in the drip tray as it is melted increases the operating efficiency of an icemaker associated with the ice and beverage dispenser.

### SUMMARY OF THE INVENTION

In accordance with the present invention, apparatus for making and dispensing ice comprises an ice dispenser having an ice dispensing chute and a sink below the chute; and an icemaker for making and delivering ice to the ice dispenser and having a high pressure refrigerant line, a portion of which refrigeration line extends within the ice dispenser sink to melt any ice in the sink.

In a preferred embodiment of the invention, an ice/beverage dispenser having a drip tray is associated with an icemaker. The icemaker includes a refrigeration system having a compressor, a condenser, an expansion valve and an evaporator. A high pressure refrigerant line extends from an outlet from the compressor to an inlet to the condenser and a further refrigerant line extends from an outlet from the condenser to an expansion valve for releasing high pressure refrigerant into an inlet to the evaporator, which refrigerant then expands and causes cooling of the evaporator. In the present invention, the refrigerant line exiting the condenser outlet does not extend directly to the expansion valve, but instead is routed through the ice/beverage dispenser drip tray before returning to the expansion valve. Refrigerant exiting the condenser has been “cooled,” but remains “warm” at a temperature of from about 100° to 140° F., and the heat energy of this refrigerant is used, as it passes through the drip tray, to melt any ice in the drip tray. As a side benefit, in the process of transferring heat energy to the ice, the refrigerant is further cooled prior to expansion of the refrigerant into the evaporator, which improves the cooling performance and operating efficiency of the refrigeration system.

The invention also contemplates a method of eliminating ice from a sink of an ice dispenser that is associated with an icemaker for making and delivering ice to the ice dispenser and that has a high pressure refrigerant line. The method comprising the step of thermally coupling a portion of the refrigerant line to ice in the sink.

In a preferred practice of the method, ice is eliminated from a drip tray of an ice and beverage dispenser that has an associated icemaker that makes ice for dispensing by the dispenser. The icemaker is of a type that utilizes a compressor, a condenser, an evaporator and an expansion valve having an inlet coupled to high pressure refrigerant at an outlet from the condenser and an outlet coupled to an inlet to the evaporator. To melt ice in the drip tray, the method comprises the step of thermally coupling the high pressure refrigerant to the ice.

### BRIEF DESCRIPTION OF THE DRAWINGS

FIG. 1 is a perspective view of an icemaker and an ice and beverage dispenser that embody the teachings of the present invention;

FIG. 2 is a schematic representation of the icemaker and the ice and beverage dispenser;

FIG. 3 is a top plan view of a heated drip tray of the ice and beverage dispenser, and

FIG. 4 is a cross-sectional view of another embodiment of heated drip tray.

### DETAILED DESCRIPTION

The present invention is adapted for use with an ice and beverage dispenser having an associated icemaker as shown in FIG. 1 and indicated generally at 10. The dispenser 10 is adapted to rest on a countertop 11 or other suitable surface and includes an upper ice making portion or icemaker 12 having an external housing 13 and a lower ice and beverage dispensing portion or ice/beverage dispenser 14 having an external housing 16. The icemaker 12 includes a refrigeration system including a compressor 18, a condenser 20 and an ice making evaporator 22. The ice/beverage dispenser 14 includes a merchandising cover 24, an ice dispensing chute 26, a splash panel 27 and a plurality of post-mix beverage dispensing valves 28.

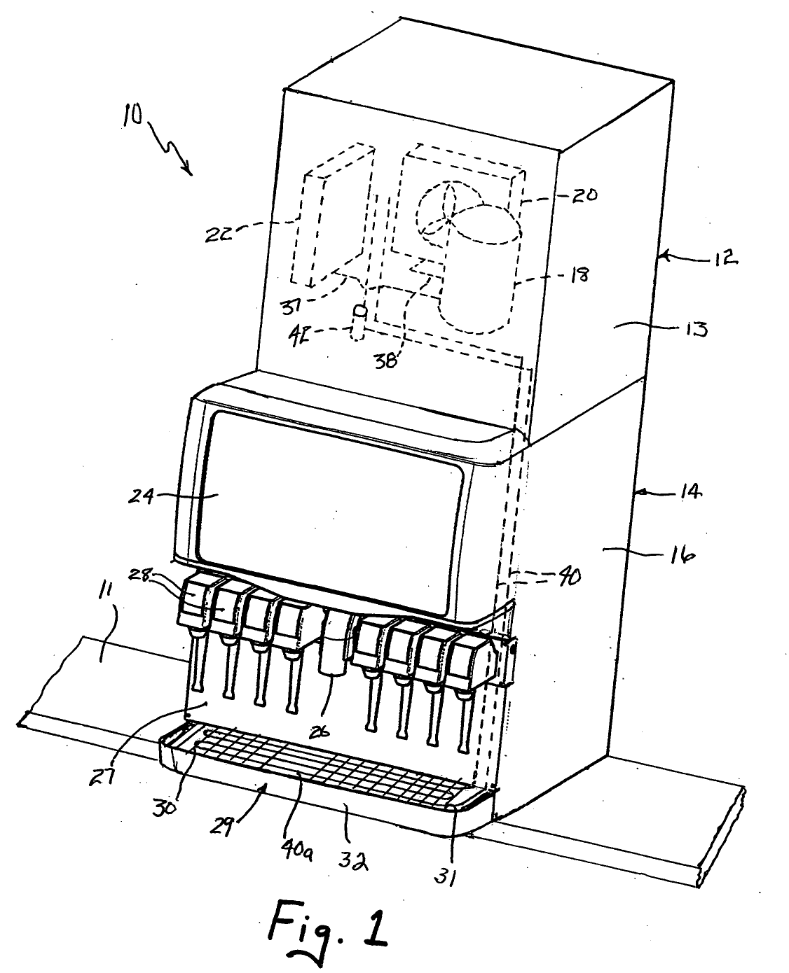

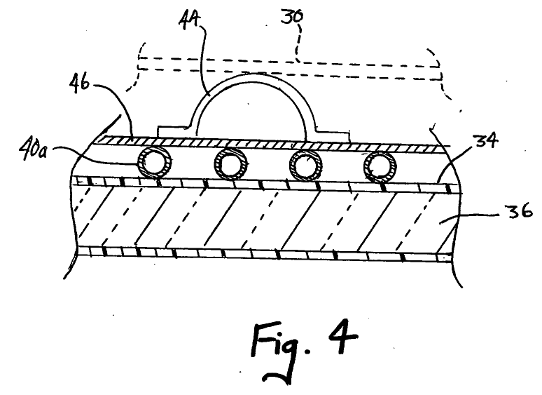

Referring also to FIG. 2, a drip tray or sink, indicated generally at 29, is at the lower front of the ice/beverage dispenser 14 and is positioned below the ice dispensing chute 26 and the beverage dispensing valves 28. The drip tray 29 includes a removable cup rest or metal grate 30 resting on an upper perimeter edge 31 of perimeter walls 32 of the drip tray. A drip tray volume or interior space 33 is defined within the drip tray 29 below the grate 30, within the perimeter walls 32 and above a bottom drain surface 34 of the drip tray. The bottom drain surface 34 serves to direct waste fluids as may enter the drip tray to a drain 35. As is conventional, the drip tray can be a rigid plastic structure and include foam insulation material 36 (FIG. 4)

In use of the dispenser 10, ice dispensed from the ice dispensing chute 26 that does not enter a receptacle or cup can accumulate in the interior 33 of the trip tray 29 and on the drip tray top grate 30. So that an accumulation of such ice can be eliminated before it presents problems, according to the present invention a readily available source of heat from the icemaker 12 is used to melt any ice as may enter the drip tray 29 or rest on its grate 30. This source of heat from the icemaker is the “heat-of-rejection” produced at the condenser 20, which heat is rejected as “waste” heat in operation of the icemaker in order to cool the evaporator 22 to make ice. The condenser 20 typically operates at a temperature in the range of from about 110° to 140° F., and this heat energy can be tapped and delivered to the drip tray or sink area to melt any ice as may accumulate in the drip tray 29 and/or on its grate 30. A typical 500 pound per day icemaker rejects over about 11,000 Btu per hour during ice making cycles, only a small portion of which heat need be utilized to effectively melt any accumulation of such ice. This may be accomplished by routing a high pressure refrigerant line that exits the condenser 20 into the interior 33 of the drip tray 29 or to a heat sink located in the drip tray interior, so that a safe and effective supply of heat will be delivered to the drip tray interior to melt any ice accumulated therein. Under the circumstance where no ice is present in the drip tray, temperatures in the drip tray will not rise excessively and will remain at safe levels. A side benefit realized by directing evaporator heat to the drip tray is that a small performance gain will be realized by the icemaker in the melting of ice as a result of additional sub-cooling of the high pressure refrigerant when the refrigerant gives up heat to melt ice in the ice tray.

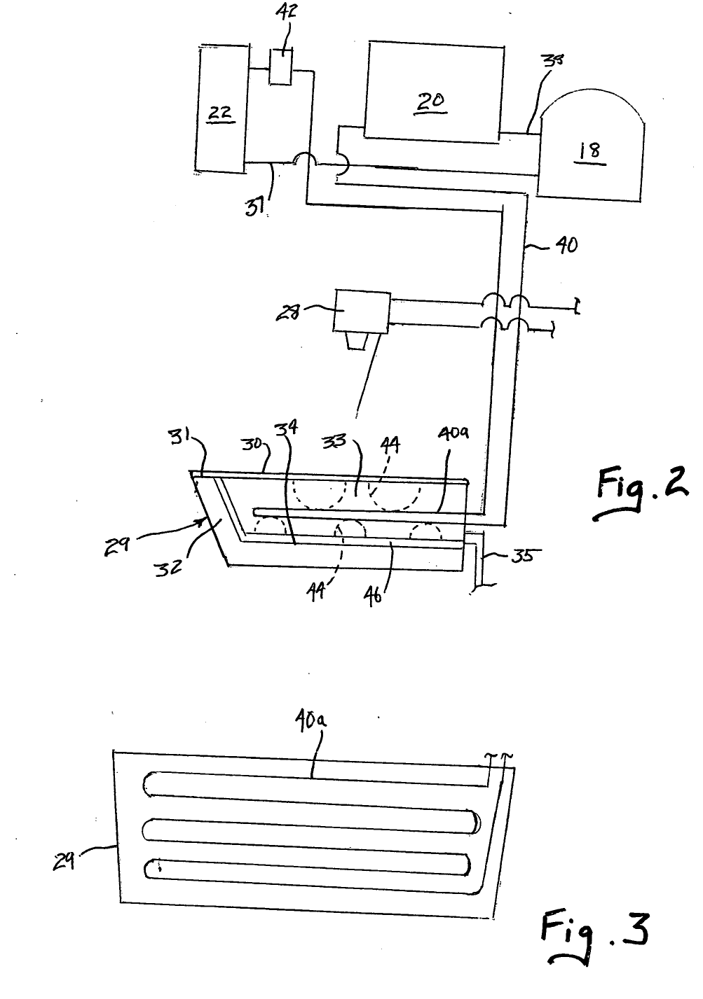

As best seen in FIG. 2, the refrigeration system of the icemaker 12 includes a low pressure refrigerant line 37 extending between an outlet from the evaporator 22 and an inlet to the compressor 18 and a high pressure refrigerant line 38 extending from an outlet from the compressor to an inlet to the condenser 20. Another high pressure refrigerant line 40 extends between an outlet from the condenser 20 and an expansion valve 42 coupled to an inlet to the evaporator 22. However, unlike the situation that exists in a conventional icemaker where a high pressure refrigerant line at an outlet from a condenser would lead directly to an expansion valve, according to the invention the high pressure refrigerant line 40 is routed from the condenser outlet first downward through and within the housing 16 of the ice/beverage dispenser 14 to a lower front end of the housing where the line exits forward from the housing into the interior space 33 of the drip tray 29. As also seen in FIG. 3, the refrigerant line 40 includes a tortuously configured portion, such as a serpentine portion 40a, that is located and extends in a plane within the interior space 33 of the drip tray 29. Beyond or downstream from (with respect to the direction of refrigerant flow) its serpentine portion 40a, the refrigerant line 40 extends rearward back into the ice/beverage dispenser housing 16 and then returns upward through and within the housing to the expansion valve 42 of the icemaker 12. As is apparent and will be more fully described, in operation of the icemaker 12 the serpentine portion 40a of the high pressure refrigerant line 40 will be warm and the heat provided by the serpentine portion within the drip tray will melt ice in the drip tray and on its grate.

The drip tray grate 30 is preferably made of stainless steel for heat conductivity, strength, resistance to rust and appearance, and is in heat exchange relationship with the serpentine line portion 40a of the high pressure refrigerant line 40 within the interior 33 of the drip tray 29. Various thermally conductive heat exchange support/connecting structures 44 can be removably placed within the interior 33 of the drip tray 29 to provide for retention of the refrigerant line serpentine portion 40a in a fixed position within the drip tray and in heat exchange relationship with the grate 30. To provide satisfactory heat exchange relationship and good thermal conductivity between the grate 30 and the refrigerant line portion 40a, the support structures 44 are advantageously made of a suitable heat conducting material, such as aluminum or stainless steel. As seen in FIG. 2, further thermal mass and ice melting capability can be provided in the drip tray 29 by a metal plate or liner 46 extending on and along the drip tray bottom drain surface 34, which plate is placed in thermal contact with the high pressure refrigerant line serpentine portion 40a by means of thermal connectors 44 extending between the plate and the serpentine line portion. In an alternative arrangement shown in FIG. 4, the refrigerant line serpentine portion 40a can be positioned below the metal plate or liner 46, between the plate and the drip tray bottom drain surface 34, so that it is more protected from accidental mechanical damage. In this alternative embodiment, removable thermal connectors 44 may be used to provide thermal connection between the plate 46 and the grate 30 as the plate is heated by the refrigerant line serpentine portion 40a.

In operation of the invention, when the icemaker 12 operates to make ice, hot high pressure refrigerant flows through the refrigerant line 38 from the outlet from the compressor 18 to the inlet to the condenser 20. As is understood, the hot refrigerant is cooled by the operation of condenser 20, but the refrigerant as it leaves the condenser and flows through the refrigerant line 40 will still be warm. This warm refrigerant flows through the refrigerant line 40 to and through the refrigerant line serpentine portion 40a within the interior 33 of the drip tray 29, where the warm refrigerant gives up heat energy to melt any ice in the drip tray or as may be resting on the drip tray grate 30. Melting of ice within the drip tray and on its grate will be enhanced to the extent that there is suitable thermal mass with which the high pressure refrigerant line serpentine portion 40a is in thermal contact, such as the grate 30, the metal connectors 44 and the metal liner 46.

An additional benefit to melting ice in the drip tray 29 through use of warm refrigerant exiting the condenser 20 of the icemaker 12 is that the heat exchange process will result in high pressure refrigerant in the refrigerant line 40 being further cooled before it reaches and passes through the expansion valve 42 into the evaporator 22, which will improve the cooling ability and efficiency of the of the icemaker. Consequently, in the process of advantageously using warm refrigerant to melt and eliminate the problems associated with an accumulation of waste ice in the drip tray 29, the capacity of the waste ice to absorb heat from the refrigerant beneficially results in improvements in icemaker operating efficiency.

While embodiments of the invention have been described in detail, various modifications and other embodiments thereof may be devised by one skilled in the art without departing from the spirit and scope of the invention, as defined in the appended claims.

1. Apparatus for making and dispensing ice, comprising an ice dispenser having an ice dispensing chute and a sink below said chute; and an icemaker for making and delivering ice to said ice dispenser and having a high pressure refrigerant line a portion of which refrigeration line extends within said ice dispenser sink to melt any ice in said sink.

2. Apparatus as in claim 1, wherein said portion of said refrigerant line has a tortuous configuration.

3. Apparatus as in claim 1, wherein said portion of said refrigerant line has a serpentine configuration.

4. Apparatus as in claim 2, wherein said portion of said refrigeration line generally lies in a plane.

5. Apparatus as in claim 1, wherein said sink has an open upper end, and including a metal grate supported by said sink over said open upper end, and means for thermally coupling said portion of said refrigerant line to said metal grate.

6. Apparatus as in claim 5, wherein said means for thermally coupling comprises at least one metal connector for supporting said portion of said refrigerant line above a bottom surface of said sink and below and in thermally coupled relationship with said.

7. Apparatus as in claim 6, including a metal plate on a bottom surface of said sink, said at least one metal connector supporting said portion of said refrigerant line above and in thermally coupled relationship with said plate and below and in thermally coupled relationship with said.

8. Apparatus as in claim 1, wherein said portion of said refrigerant line is on a bottom surface of said sink, and including a metal plate in said sink on top of said portion of said refrigerant line, a metal grate supported by said sink over and across an open upper end of said sink, and means for thermally coupling said refrigerant line to each of said plate and said grate.

9. Apparatus for dispensing ice and a beverage and for making ice, comprising an ice and beverage dispenser having an ice dispensing chute and a drip tray below said chute; and an icemaker having a compressor, a condenser, an evaporator, an expansion valve having an outlet coupled to an inlet to said evaporator, and a high pressure refrigerant line extending between an outlet from said condenser and an inlet to said expansion valve, said refrigerant line carrying high pressure warm refrigerant and a portion of said refrigerant line extending within said drip tray.

10. Apparatus as in claim 9, wherein said icemaker is above said ice and beverage dispenser, said ice and beverage dispenser is contained within a housing, said drip tray is at a lower outer end of said housing, and said refrigerant line extends from said icemaker condenser outlet downward through said housing to and into said drip tray and then out of said drip tray and upward through said housing to said expansion valve inlet.

11. Apparatus as in claim 9, wherein said portion of said refrigerant line within said drip tray has a tortuous configuration.

12. Apparatus as in claim 9, wherein said portion of said refrigerant line within said drip tray has a serpentine configuration.

13. Apparatus as in claim 9, wherein said portion of said refrigeration line within said drip tray generally lies in a single plane.

14. Apparatus as in claim 9, wherein said drip tray has an open upper end, and including a metal grate supported on said drip tray over said open upper end, and means thermally coupling said portion of said refrigerant line to said metal grate.

15. Apparatus as in claim 14, wherein said means for thermally coupling comprises at least one metal connector for supporting said refrigerant line portion above a bottom surface of said drip tray and below and in thermally coupled relationship with said grate.

16. Apparatus as in claim 15, including a metal plate on a bottom surface of said sink, said at least one metal connector supporting said refrigeration line portion above and in thermally coupled relationship with said plate and below and in thermally coupled relationship with said grate.

17. Apparatus as in claim 9, wherein said portion of said refrigerant line is on a bottom surface of said drip tray, and including a metal plate in said drip tray on top of said refrigerant line portion, a metal grate supported by said drip tray over an open upper end of said drip tray, and means for thermally coupling said plate to said grate.

18. A method of eliminating ice from a sink of an ice dispenser that is associated with an icemaker for making and delivering ice to the ice dispenser and that has a high pressure refrigerant line, said method comprising the step of thermally coupling a portion of the refrigerant line to ice in the sink.

19. A method as in claim 18, wherein said thermally coupling step comprises positioning a portion of the refrigerant line within the sink.

20. A method as in claim 19, including the step of imparting a tortuous configuration to the portion of the refrigeration line within the sink.

21. A method as in claim 18, wherein the ice dispenser includes a metal grate supported on an open upper end of the sink and said thermally coupling step also includes thermally coupling the portion of the refrigerant line to the grate.

22. A method as in claim 19, including the step of supporting the portion of the refrigerant line in the sink above a lower surface of and below an open upper end of the sink.

23. A method of eliminating ice from a drip tray of an ice and beverage dispenser that is associated with an icemaker that makes ice for dispensing by the dispenser, wherein the icemaker is of the type that utilizes a compressor, a condenser, an evaporator and an expansion valve having an inlet coupled to high pressure refrigerant at an outlet from the condenser and an outlet coupled to an inlet to the evaporator, said method comprising the step of melting ice in the drip tray by thermally coupling high pressure refrigerant to the ice.

24. A method as in claim 23, wherein the icemaker has a high pressure refrigerant line for delivering high pressure refrigerant from the condenser outlet to the expansion valve inlet, and said melting step comprises thermally coupling the high pressure refrigerant line to ice in the drip tray.

25. A method as in claim 24, wherein said melting step comprises thermally coupling the refrigerant line to ice in the drip tray by routing the refrigerant line through the drip tray.

26. A method as in claim 24, wherein the ice and beverage dispenser has a metal grate over the drip tray, and said melting step includes the further step of also heat coupling the refrigerant line to the metal grate.

27. A method as in claim 24, wherein the ice and beverage dispenser has a metal grate over the drip tray and a metal plate within the drip tray, and said melting step comprises the further step of thermally coupling the refrigerant line to each of the metal grate and the metal plate.
